(19) United States
(12) Patent Application Publication
(10) Pub. No.: US 2008/0052519 A1
(43) Pub. Date: Feb. 28, 2008

(54) SYSTEM AND METHOD FOR SIGNING A CONTRACT ELECTRONICALLY

(75) Inventors: CHUNG-I LEE, Tu-Cheng (TW); HAI-HONG LIN, Shenzhen (CN); GANG PENG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,939

(22) Filed: Dec. 23, 2006

(30) Foreign Application Priority Data
Aug. 9, 2006 (CN) 200610200787.1

(51) Int. Cl. H04L 9/00; G06F 12/14; H04L 9/32; G06F 11/30

(52) U.S. Cl. 713/176; 713/189

(57) ABSTRACT

A method for signing a contract electronically includes the steps of: generating a proposition contract (31) by a first party via a server (10); sending the proposition contract to a client (20); signing the proposition contract electronically by a second party via the client, thereby yielding an endorsed contract (32), and returning the endorsed contract to the server; receiving the endorsed contract sent from the client; validating whether the terms and conditions of the endorsed contract are the same as the terms and conditions of the proposition contract; validating whether the digital signature of the second party in the endorsed contract is a valid signature according to a validating digital signature of the second party stored in the server, if the terms and conditions of the endorsed contract are the same as the terms and conditions of the proposition contract; signing the endorsed contract electronically by the first party, thereby yielding an effective contract (33) if the signature of the second party is a valid signature; and validating the digital signature of the first party in the effective contract. A related system is also provided.

### BACKGROUND OF THE INVENTION

1. Field of the Invention

The present invention is related to systems and methods for signing a contract electronically.

2. Description of Related Art

A contract is an “agreement” over of a set of terms and conditions. In civil law, contracts are considered to be part of the general law of obligations. The law generally sees performance of a contract as a duty. This article describes the law relating to contracts in common law jurisdictions. For a contract to be valid, it must meet the following criteria: mutual agreement, consideration, adult (Sui Juris) parties, proper subject matter, mutual right to remedy, mutual obligation to perform, intention to create legal relationship.

However, the current way to sign a contract still fulfilled with paper contract. The current procedure of sign a contract manually is generally time-consuming and corresponding labor costs can be high. When the two parties of the contract are located at different places, they often spend a lot time to sign the contract in a concerted place.

Accordingly, what is needed is a system and method for signing a contract electronically, which can save time and labor resources.

### SUMMARY OF THE INVENTION

One preferred embodiment provides a system for signing a contract electronically. The system includes a server operated by a first party of the contract and a client operated by a second party of the contract. The server includes a contract generating module, a sending module, a receiving module, a signing module, and a validating module. The contract generating module is used for generating a proposition contract by the first party. The sending module is used for sending the proposition contract to the client. The receiving module is used for receiving an endorsed contract electronically signed by the second party and sent from the client. The signing module is used for electronically signing the endorsed contract by the first party, thereby yielding an effective contract. The validating module is used for validating whether the digital signature of the second party in the endorsed contract and the digital signature of the first party in the effective contract are valid signatures according to validating digital signatures stored in the server.

Another preferred embodiment provides a computer-based method for signing a contract electronically. The method includes the steps of: generating a proposition contract by a first party via a server; sending the proposition contract to a client; signing the proposition contract electronically by a second party via the client, thereby yielding an endorsed contract, and returning the endorsed contract to the server; receiving the endorsed contract sent from the client; validating whether the terms and conditions of the endorsed contract are the same as the terms and conditions of the proposition contract; validating whether the digital signature of the second party in the endorsed contract is a valid signature according to a validating digital signature of the second party stored in the server, if the terms and conditions of the endorsed contract are the same as the terms and conditions of the proposition contract; signing the endorsed contract electronically by the first party, thereby yielding an effective contract if the signature of the second party is a valid signature; and validating the digital signature of the first party in the effective contract.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of a system for signing a contract electronically in accordance with one preferred embodiment;

FIG. 2 is a flowchart of a method for signing a contract electronically in accordance with one preferred embodiment;

FIG. 3 is a schematic diagram of a proposition contract;

FIG. 4 is a schematic diagram of a endorsed contract; and

FIG. 5 is a schematic diagram of a effective contract.

### DETAILED DESCRIPTION OF THE INVENTION

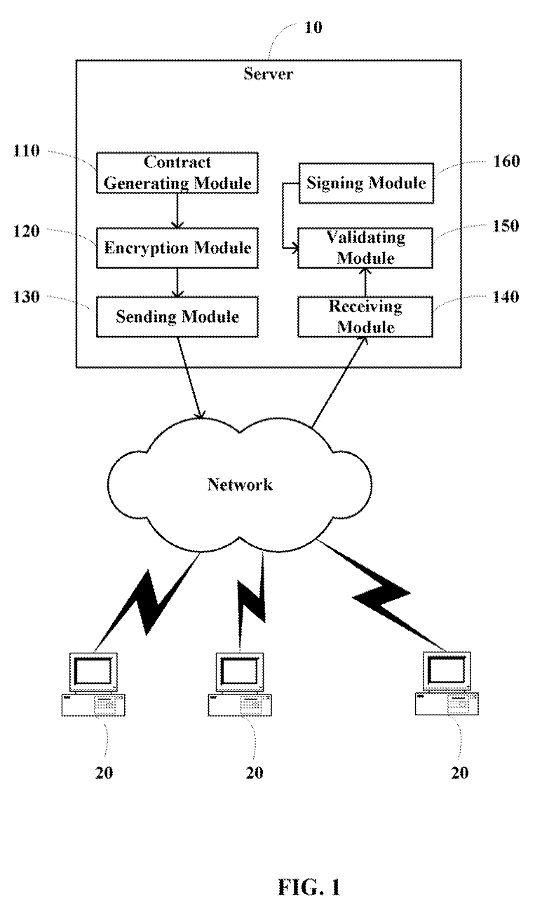

FIG. 1 is a schematic diagram of hardware configuration of a system for signing a contract electronically in accordance with one preferred embodiment. The hardware configuration may typically include a server 10 and a plurality of clients 20. The server 10 is connected with the client 20 via a network. The server 10 and the clients 20 may be notebook computers, desktop computers, or personal digital assistants (PDAs). Wherein, the server 10 is operated by a first party of a contract, and the clients 20 are operated by a second party of the contract. The server 10 mainly includes a contract generating module 110, and an encryption module 120, a sending module 130, a receiving module 140, a validating module 150, and a signing module 160.

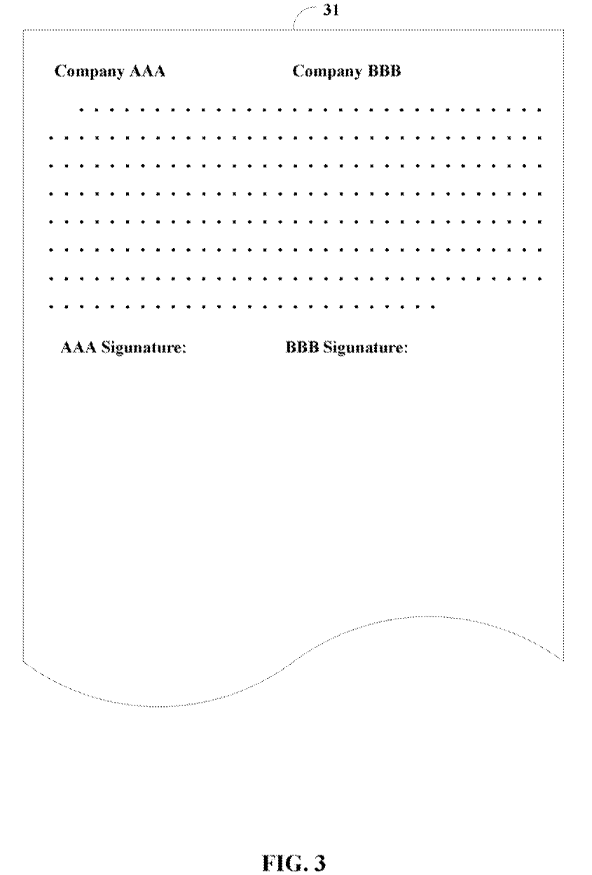

The contract generating module 110 is used for generating a proposition contract by the first party. FIG. 3 is a schematic diagram of a proposition contract 31 generated by the contract generating module 110. Wherein, the first party in the proposition contract 31 is BBB, and the second party in the proposition contract 31 is AAA. The proposition contract 31 may be in a text format or a graphic format.

The encryption module 120 is used for encrypting the proposition contract 31.

The sending module 130 is used for sending the encrypted proposition contract 31 to the client 20.

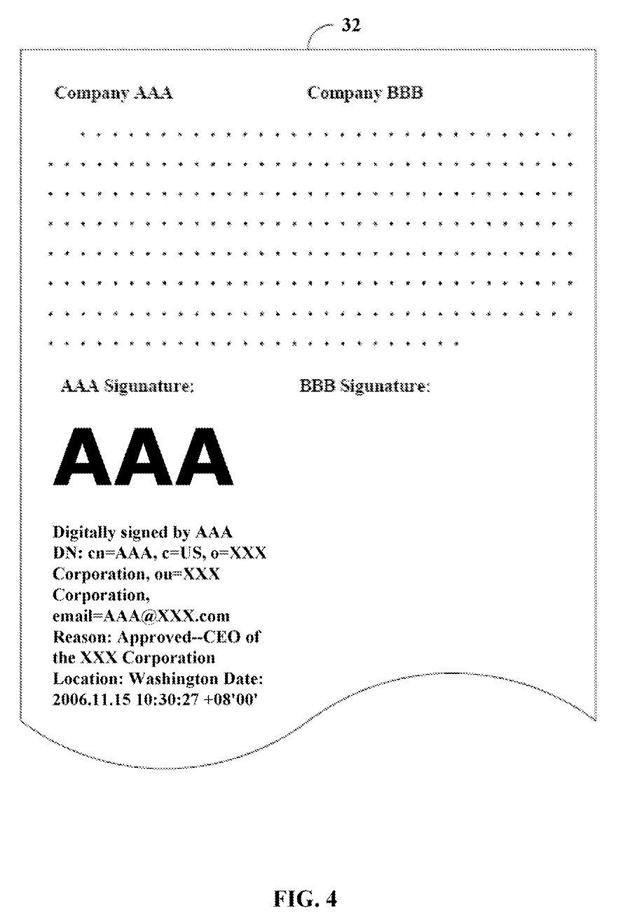

The second party obtains the proposition contract 31 by decrypting the encrypted proposition contract 31, electronically signs the proposition contract 31 via the client 20, thereby yielding an endorsed contract, and returns the endorsed contract to the server 10. FIG. 4 is a schematic diagram of an endorsed contract 32 electronically signed by the second party. The signature of the second party (AAA) in the endorsed contract 32 is depicted in the diagram AAA with: DN: cn=AAA, c=US, o=XXX Corporation, ou=XXX Corporation, email=AAA@XXX.com Reason: Approved—CEO of the XXX Corporation Location: Washington Date: 2006 Nov. 15 10:30:27 +08′00′.

The receiving module 140 is used for receiving the endorsed contract 32 sent from the client 20.

The validating module 150 is used for validating whether the terms and conditions of the endorsed contract 32 (not including the signature of the second party) are the same as the terms and conditions of the proposition contract 31.

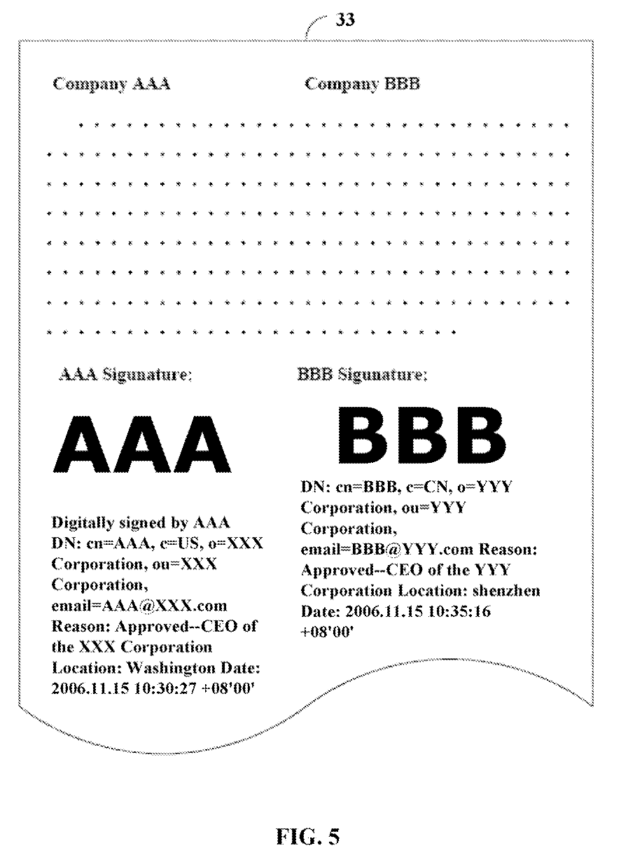

The signing module 160 is used for electronically signing the endorsed contract 32 by the first party if the terms and conditions of the endorsed contract 32 are the same as the terms and conditions of the proposition contract 31, thereby yielding an effective contract 33. FIG. 5 is a schematic diagram of an effective contract 33 electronically signed by the first party. The signature of the first party (BBB) in the effective contract 33 is depicted in the diagram BBB with: DN: cn=BBB, c=CN, o=YYY Corporation, ou=YYY Corporation, email=BBB@YYY.com Reason: Approved—CEO of the YYY Corporation Location: shenzhen Date: 2006 Nov. 15 10:35:16 +08′00′.

The validating module 150 is further configured for validating whether the digital signature of the second party in the endorsed contract 32 and the digital signature of the first party in the effective contract 33 are valid signatures according to validating digital signatures stored in the server.

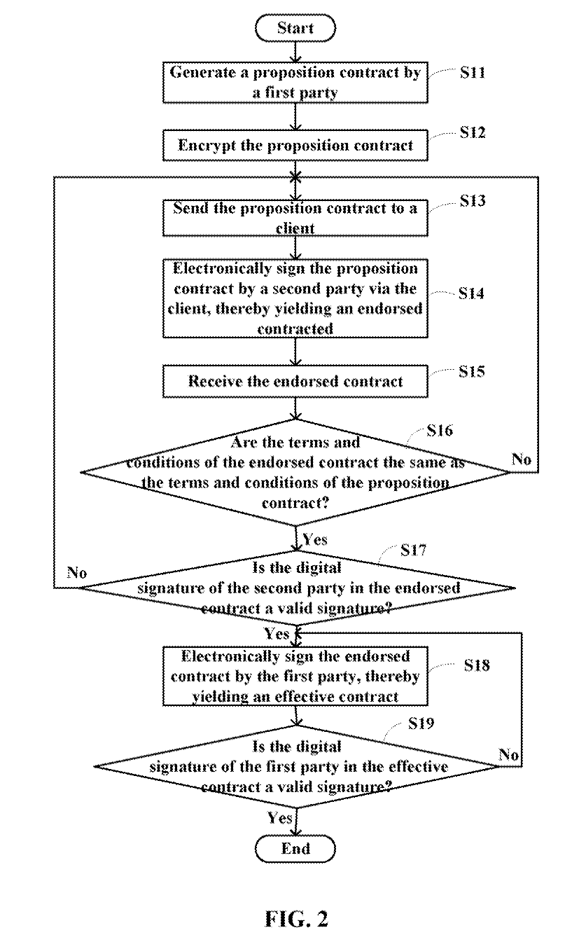

FIG. 2 is a flowchart of a method for signing a contract electronically in accordance with one preferred embodiment.

In step S11, the contract generating module 110 generates a proposition contract 31 by the first party via the server 10.

In step S12, the encryption module 120 encrypts the proposition contract 31.

In step S13, the sending module 130 sends the encrypted proposition contract 31 to the client 20.

In step S14, the second party obtains the proposition contract 31 by decrypting the encrypted proposition contract 31, electronically signs the proposition contract 31 via the client 20, thereby yielding an endorsed contracted 32, and returns the endorsed contract 32 to the server 10.

In step S15, the receiving module 140 receives the endorsed contract 32.

In step S16, the validating module 150 validates whether the terms and conditions of the endorsed contract 32 (not including the signature of the second party) are the same as the terms and conditions of the proposition contract 31.

In step S17, if the terms and conditions of the endorsed contract 32 are the same as the terms and conditions of the proposition contract 31, the validating module 150 validates whether the digital signature of the second party in the endorsed contract 32 is a valid signature according to a validating digital signature of the second party stored in the server 10.

In step S18, if the signature of the second party in the endorsed contract 32 is a valid signature, the first party electronically signs the endorsed contract 32 through the signing module 160, thereby yielding an effective contract 33.

In step S19, the validating module 150 validates whether the digital signature of the first party in the effective contract 33 is a valid signature according to a validating digital signature of the first party stored in the server 10. If the signature of the first party in the effective contract 33 is a valid signature, the procedure ends; otherwise, the procedure returns to step S18.

If the terms and conditions of the endorsed contract 32 are not the same as the terms and conditions of the proposition contract 31 in step S16, the procedure returns to the step S13 described above.

If the signature of the second party in the endorsed contract 32 is not a valid signature in step S17, the procedure returns to the step S13 described above.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for signing a contract electronically, the system comprising a server operated by a first party of the contract and a client operated by a second party of the contract, the server comprising:
a contract generating module for generating a proposition contract by the first party;
a sending module for sending the proposition contract to the client;
a receiving module for receiving an endorsed contract electronically signed by the second party and sent from the client;
a signing module for electronically signing the endorsed contract by the first party, thereby yielding an effective contract; and
a validating module for validating whether the digital signature of the second party in the endorsed contract and the digital signature of the first party in the effective contract are valid signatures according to validating digital signatures stored in the server.

2. The system according to claim 1, wherein the server further comprises:
an encryption module for encrypting the proposition contract before sending the proposition contract to the client.

3. A computer-based method for signing a contract electronically, the method comprising the steps of:
generating a proposition contract by a first party via a server;
sending the proposition contract to a client;
signing the proposition contract electronically by a second party via the client, thereby yielding an endorsed contract, and returning the endorsed contract to the server;
receiving the endorsed contract sent from the client;
validating whether the terms and conditions of the endorsed contract are the same as the terms and conditions of the proposition contract;
validating whether the digital signature of the second party in the endorsed contract is a valid signature according to a validating digital signature of the second party stored in the server, if the terms and conditions of the endorsed contract are the same as the terms and conditions of the proposition contract;
signing the endorsed contract electronically by the first party, thereby yielding an effective contract if the signature of the second party is a valid signature; and
validating the digital signature of the first party in the effective contract.

4. The method according to claim 3, further comprising the step of: encrypting the proposition contract before the sending step.

5. The method according to claim 4, further comprising the step of: decrypting the proposition contract before the step of signing the proposition contract.

6. The method according to claim 3, wherein if the terms and conditions of the endorsed contract are not the same as the terms and conditions of the proposition contract, the procedure returns to the sending step.

7. The method according to claim 3, wherein if the digital signature of the second party is not a valid signature, the procedure returns to the sending step.
